(19) United States
(12) Patent Application Publication
(10) Pub. No.: US 2002/0097852 A1
(43) Pub. Date: Jul. 25, 2002

(54) METHOD FOR CHARGING CALLS IN A COMMUNICATIONS NETWORK

(76) Inventors: CARLOS HUYGHE, DE PINTE (BE); DIRK DE BOSSCHER, MUNCHEN (DE); DIRK REINER, ZELZATE (BE); JAN HAMANN, MUNCHEN (DE)

Correspondence Address: SCHIFF, HARDIN & WAITE, PATENT DEPARTMENT, 233 SOUTH WACKER DRIVE, 7100 SEARS TOWER, CHICAGO, IL, 60606-6473, US

(21) Appl. No.: 09/424,413

(22) PCT Filed: Apr. 20, 1998
(86) PCT No.: PCT/EP98/02316

(30) Foreign Application Priority Data
May 22, 1997 (DE) 97108324.1

(51) Int. Cl. H04M 15/00

(52) U.S. Cl. 379/114.01; 379/114.28

(57) ABSTRACT

The invention is based on the object of specifying a method for fee scheduling that enables a flexible fee scheduling in deregulated networks. This object is achieved in that a tariff of a connection is explicitly indicated in a tariff message.

The monopoly-defined network structure is being expanded due to the deregulation of the telecommunication market to the affect that a greater plurality of new network operators offer telephone service in addition to the previous PTTs. In the competition resulting therefrom, fee schedules represent a type of competitive means and must therefore be changeable at short notice, i.e. these are not agreed upon by the network operators before a change.

Up to now, i.e. in a monopolistic network structure, the fee schedules were established network-wide such that a pointer (charge band number) could be transported through the network in order to inform an exchange of a fee schedule. In this way, the fee schedule was transported from the exchange determining (defining) the fee schedule to the exchange processing the fee schedule. Said pointer allowed the exchange processing the fee schedule and unambiguous allocation of the fee schedules within the boundaries of a network via a corresponding table. This mechanism, however, assumes the same administration of the fee schedules (i.e., of the tables in the exchanges processing the fee schedule) network-wide. This same administration of the fee schedules, however, is no longer established in deregulated networks.

The invention is based on the object of specifying a method for fee scheduling that enables a fee scheduling in deregulated networks, i.e. networks having different administration.

Said object is achieved by a method according to the features of claim 1.

Given decentralized fee schedule determination (fee schedule definition), the inventive method achieves the effect that charges (for example, for IN services) can be acquired in a single exchange even though the fee schedules were determined in various exchanges.

Given centralized fee schedule processing (for example, charge determination), the inventive method achieves the effect that an operator can combine and, potentially, convert all or some of the fee schedules of a connection.

A development of the invention is established by claim 5. As a result of this development, an exact switching of fee schedules at absolute switchover points in time is assured given fee schedule changes in the fee schedule processing point without producing a load on the network with message bursts due to fee schedule messages for this purpose.

One development of the invention is established by claim 6. As a result of this development, only a single fee schedule message is required for the majority of connections.

One development of the invention is established by claim 7. Due to this development, an immediate switching from an ongoing onto the arriving fee schedule (immediately after arrival of the fee schedule with the message) is enabled.

An exemplary embodiment of the invention is explained in greater detail below with reference to the drawing.

First, the procedure of charging is explained in greater detail, this being capable of being divided into three individual operations, namely the fee schedule determination, the charge data acquisition (charge registration) and the billing.

What is to be understood by fee schedule determination is the determination of the fee schedule of a connection on the basis of the distance (source/destination relationship), the time (for example, week day, time of day) and/or further supplementary criteria (such as, for example, the transmission quality).

What is to be understood by charge data acquisition is the connection-individual production of a data set (also referred to as record below) with all data required for the later billing or, respectively, the immediate conversion of the fee schedule into charge units and into the acquisition with subscriber-related charge counters.

What is to be understood by billing is the subscriber-related compiling and evaluation of the data sets that have been produced or, respectively, charge counter readings for a defined accounting interval.

The fee schedule determination and charge data acquisition is implemented by the exchanges that are supplied by the equipment suppliers such as, for example, Siemens. These exchanges are connected to form a respective network and are operated within the network by the operating companies such as, for example, Deutsch Telekom.

The billing, finally, is implemented by a post-processing that runs on separate large computers. The interface between exchanges and large computer is realized by the periodic transmission of the data sets that have been produced or, respectively, of the subscriber fee counters.

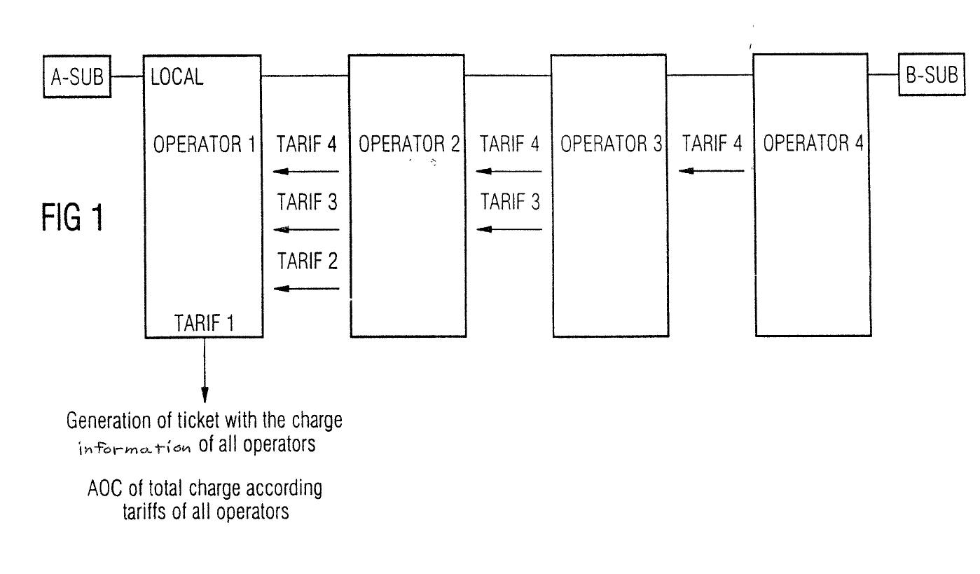

FIG. 1 shows the example of a central charge data acquisition by the originating exchange (local exchange).

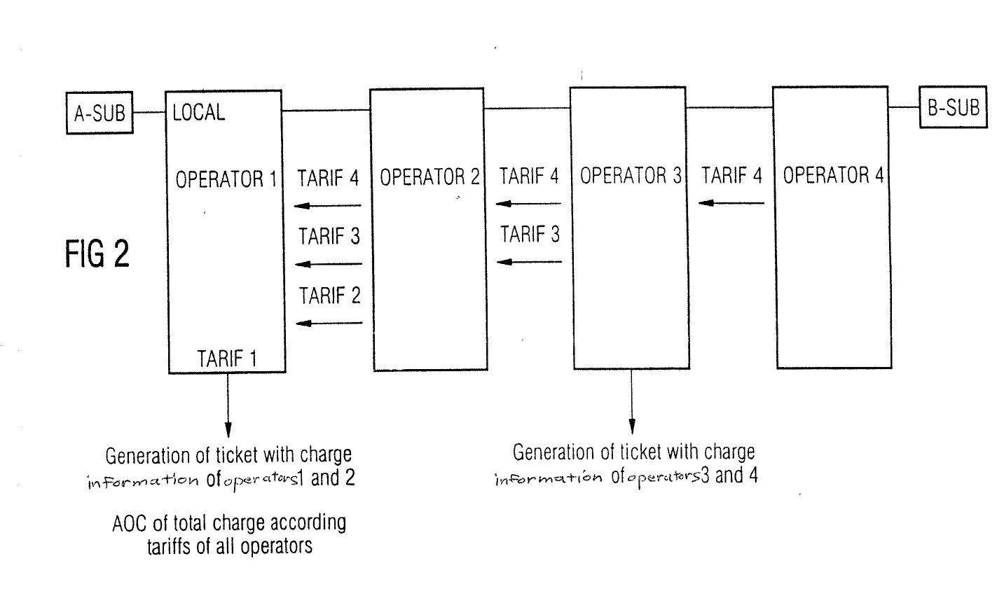

FIG. 2 shows the example of a decentralized charge data acquisition by a plurality of exchanges.

The new fee schedule messages CRGE, CRA, and CRAO are explained in greater detail below.

The new fee schedule messages wherein a fee schedule is explicitly recited, i.e. in fee schedule units (for example, in a currency format or a meter pulse format) for fee schedule interval (time clock) enable a fee scheduling in deregulated networks, i.e. networks having different administration.

The fee schedule message CRGE enables three different methods of changing fee schedules, namely,

a fee schedule change upon reception of the fee schedule message (also referred to below as “immediate” fee schedule change),

a fee schedule change given expiration of what is referred to as the fee schedule duration (time duration within which the currency rate is valid),

a fee schedule change at an absolute (fee schedule) switchover time.

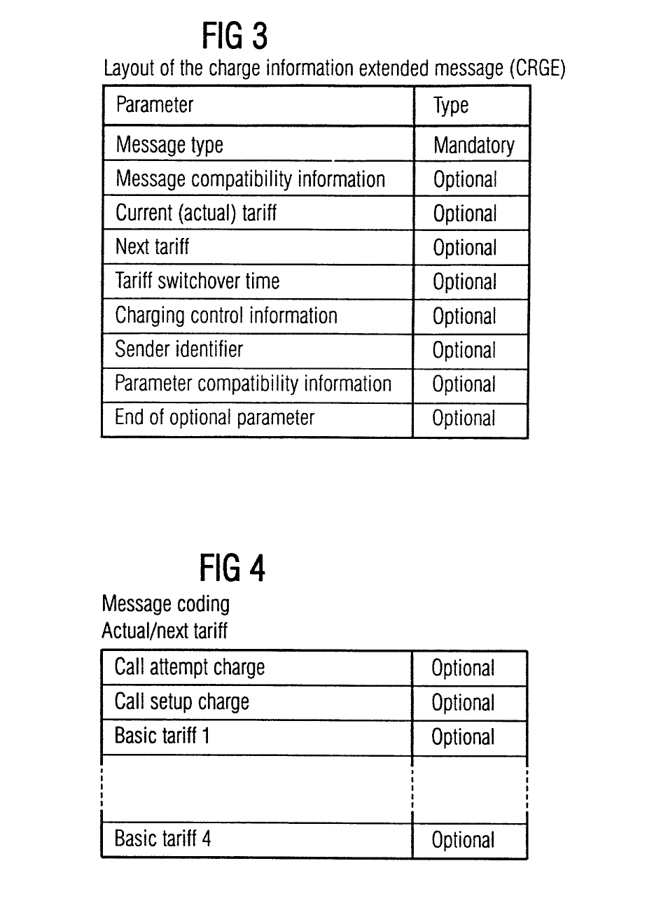

FIG. 3 shows the layout of the fee schedule message CRGE.

The layout comprises a component “message type” that indicates what message is in fact involved. The correct application is selected at the recipient on the basis of the “message type”.

The layout further comprises a component “tariff control information” that, among other things, contains what is referred to as the charge indicator that indicates whether the fee schedule message is allowed to be processed by the exchange receiving the fee schedule message for the purpose of charge registration or not. In the latter instance, the fee schedule has already been processed for the purpose of charge registration and has only been sent back to the originating exchange for the purpose of indicating the charges.

The layout further comprises a component “sender identifier” that contains the operator identifier and/or the signaling point code of that exchange that defined the fee schedule.

The layout, finally, comprises the components “current fee schedule”, “next-successive fee schedule” and “absolute fee schedule switching time”, whose significance will become clear below.

During the connection setup of a connection (call), the fee schedule message CRGE is optimally utilized when the following information are to be transmitted:

the current fee schedule that must be immediately activated. Said fee schedule can comprise a fee schedule sequence of up to four basic fee schedules. Each fee schedule comprises a currency rate (currency units per fee schedule time interval) and a fee schedule duration (whole multiple of said fee schedule time interval) within the which the currency rate is valid;

the next (next-successive) fee schedule that must be activated at an absolute switchover point in time;

said absolute switch over point in time.

When said fee schedule message during the call condition (active phase of a call) comprises the information “current fee schedule”, then this is interpreted to the affect that the previously current fee schedule must be immediately replaced (replace tariff immediately!”.

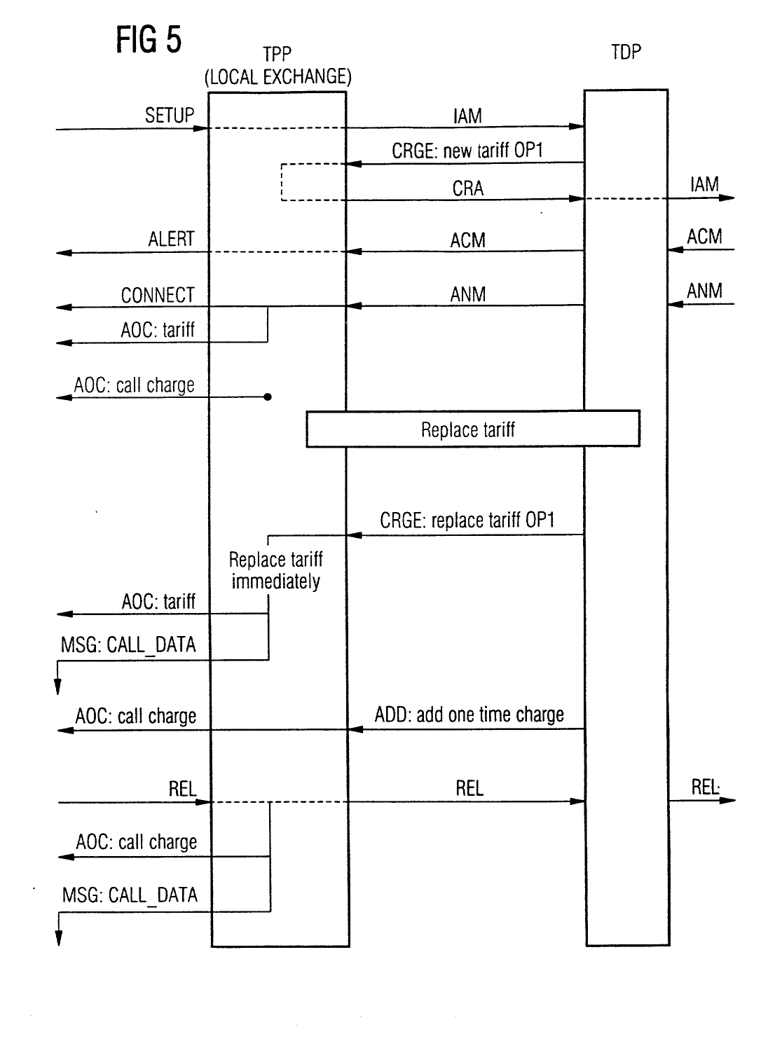

FIG. 4 shows the layout of the information for the current fee schedule contained in the fee schedule message CRGE. The layout for the current fee schedule is identical to the layout for the next fee schedule; however, there are differences in the purpose of the elements containing the layout and in the activation time.

The information element “current fee schedule” is contained in what is the first fee schedule message of an operator for a call (more precisely, a specific operator/charge type combination). The specification of this information in the first fee schedule message is compulsory since it represents the first fee schedule that is activated given this call for the corresponding operator.

The information element “current fee schedule” can, further, be contained in every following fee schedule message for a specific operator/charge type combination, i.e. it is optional in this case. When this optional information is sent, then it immediately replaced the current fee schedule (replace tariff immediately!).

The information “next tariff” represents an optional information component in the first and in the following fee schedule messages for a specific operator/charge type combination. When Said information, however, is sent then it replaces the currently active fee schedule at that absolute switch over time that is indicated in the information component “fee schedule switch over time”.

An information “next tariff” that has already been sent is overwritten by a new information about its “next tariff” sent with a further fee schedule message.

In order to avoid bursts due to the transmission of fee schedule messages with “next” tariffs at the fee schedule switching time, it is optimum to send the information “next tariff” together with the first fee schedule message.

Of course, bursts can still also be avoided with increased transmission outlay when the information “next tariff” is not sent until a further fee schedule message.

The fee schedule message CRGE thus offers the following advantages:

possibility of immediate switching from an ongoing to the arriving tariff (immediately after arrival of the tariff with the message),

possibility of second-precise application/activation of the tariff when the message “ANSWER” (=answering of the B-subscriber) arrives in the connection setup;

possibility of second-precise switching at absolute switch over times given simultaneously avoiding of the load of the network with message bursts at absolute switch over times such as, for example, 18:00 o'clock or 21:00 o'clock. At these switch over times, a respective message would have to be sent off otherwise per existing connection, which would lead to a considerable load on the network (potentially to the collapse thereof). The message bursts, to be more precise, are avoided in that a time-offset transmission of the fee schedule message with the switch over times contained therein ensues (each call starts, of course, at a different time) and the next tariff following at an absolute switch over time is already contained in a fee schedule message (90% of all calls last longer than three through five minutes, so that one second tariff (next-successive tariff) is generally adequate).

The fee schedule message CRAO (Charge Add On Message) represents a time-independent fee schedule information (one-time surcharging) that is surcharged once onto the tariff already active. The registration of this surcharging ensues either by an additional, separate storing and/or addition onto the payment already calculated on line. With the assistance of said message, a charge data acquisition that is already ongoing and potentially active is thus not disturbed or, respectively, interrupted when a fixed charge arises during the connection (for example, for a charge-incurring page in the Internet).

The acknowledgment of the fee schedule messages that have arrived ensues with the acknowledgment message CRA. As a result of said acknowledgment, the (legal) certainty is assured for the later delineation between operators. Moreover, the communication of the identifier of the operator that acquires and/or converts the tariff ensues with said message in order to make this operator known to the operator transmitting the tariff.

FIGS. 5 through 8 show message flows that occur in conjunction with the charging.

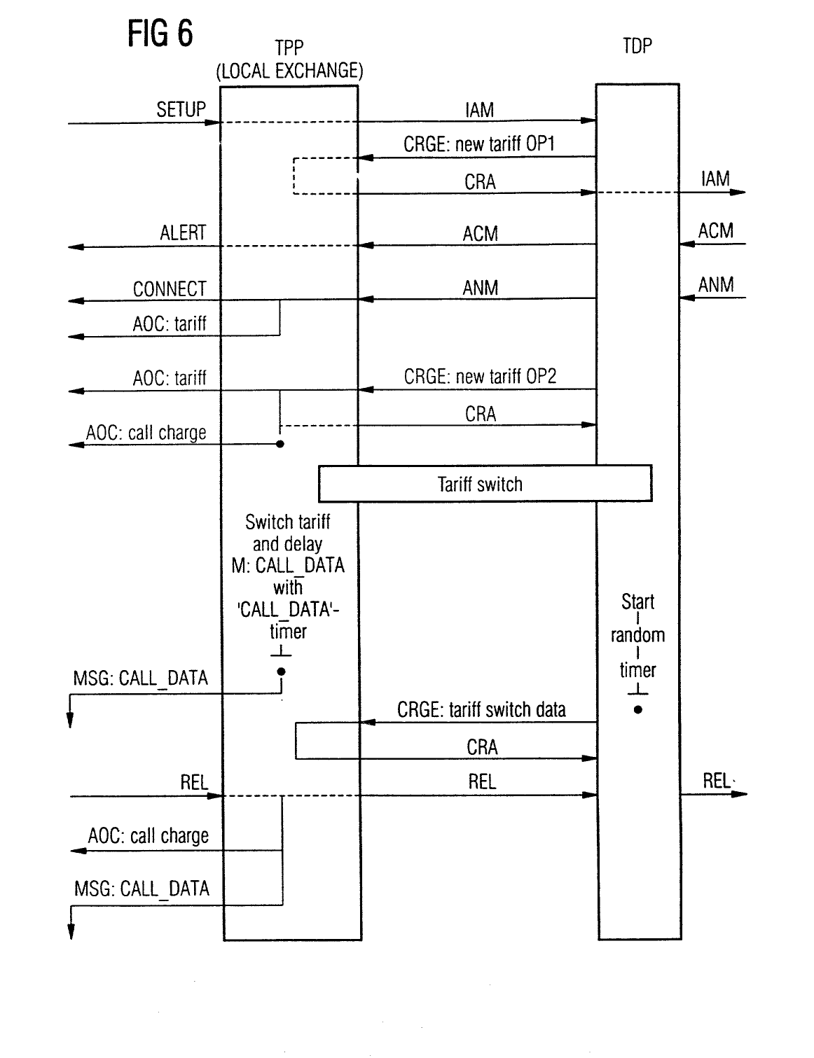

FIGS. 5 and 6 show the message flows for that case wherein the charge registration ensues in the local exchange, whereby FIG. 5 shows an immediate fee schedule change in combination with add on charges, and FIG. 6 shows a fee schedule change at an absolute switch over time.

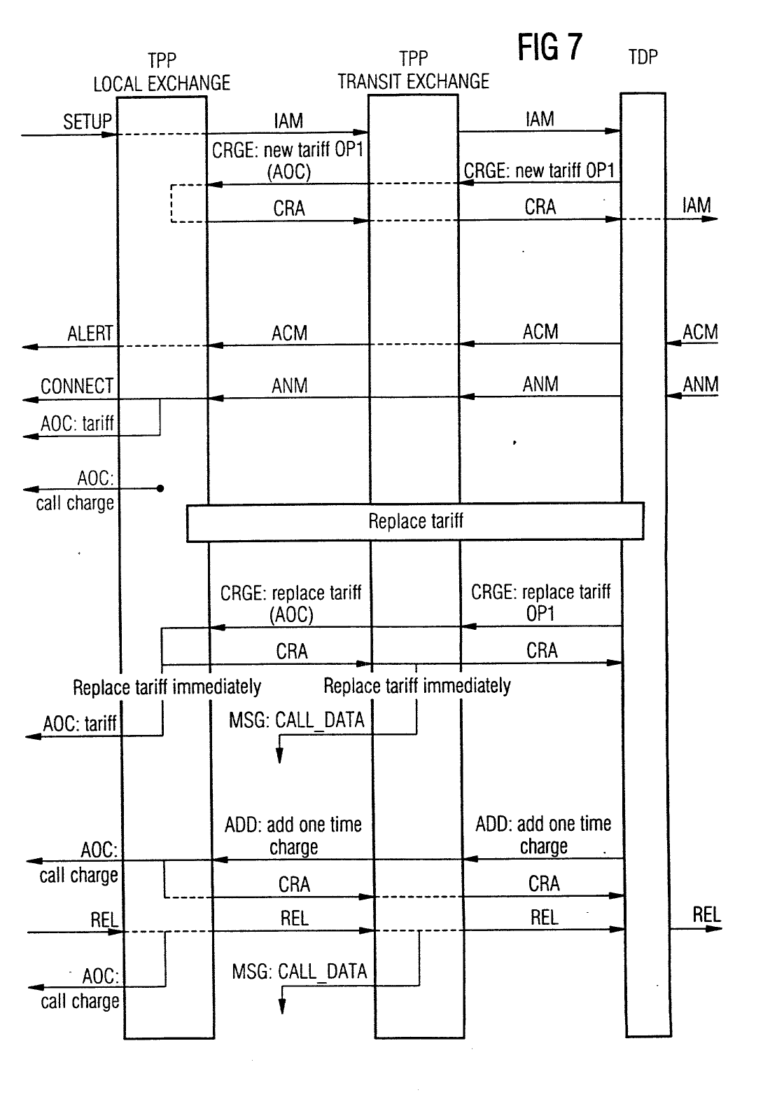

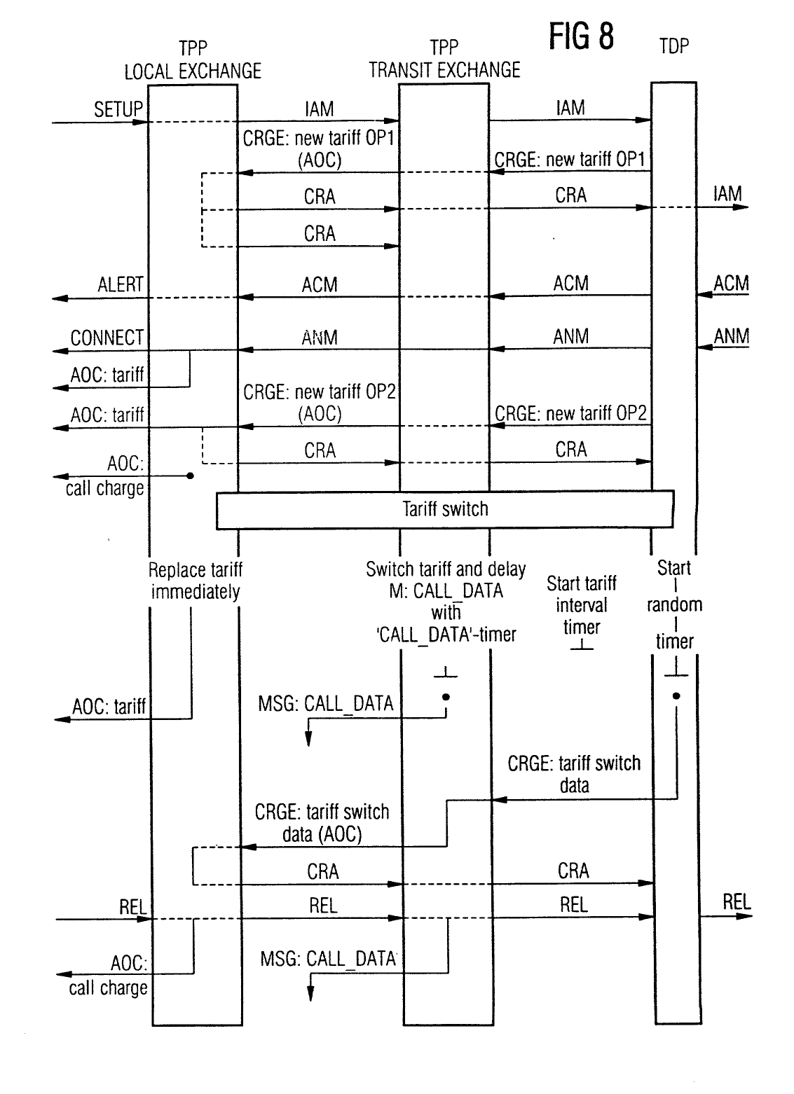

FIGS. 7 and 8 show the message flows for that case wherein the charge registration ensues in a transient exchange and only the charge display ensues in the local exchange, whereby an immediate fee schedule change is shown in FIG. 7 and a fee schedule change at an absolute switch over time is shown in FIG. 8.

The messages indicated abbreviated in FIGS. 5 through 8 are explained below.

The messages SETUP and IAM (Initial Address Message) serve the purpose of connection setup. The IAM contains, among other things, the information as to whether the fee schedule stipulation for the sub-network of a respective operator was already implemented by a preceding exchange or not.

The message ACM (Address Complete Message) signals the A-subscriber exchange that no further address identification numbers are required.

The message ALERT signals the A-subscriber that the B-subscriber is not busy and a ringing character is now sounding thereat.

The message ANM (Answer) signals the A-exchange that the B-subscriber has become active (for example, has picked up his receiver).

The message CONNECT initiates the through connection of a voice channel between A-subscriber exchange and the A-subscriber.

As can be seen from FIGS. 5 through 8, the forwarding IAM message from the TDP only ensues after the charge acknowledgment message CRA was received from the point processing the tariff.

When the subscriber has the authorization for the advise of charge (AOC), the fee schedule valid for the connection is communicated to him when the subscriber answers. The charges arising during the connection are periodically displayed to the subscriber.

When the operator in the TDP decides for an immediate tariff change, the new tariff is transferred to the TPP with the CRGE message. Upon arrival of this message

the current tariff is immediately replaced by the new tariff,

the new tariff is displayed to the subscriber (AOC),

triggered by the CALL_DATA message of the GP to the CP, a data set (record, ticket) is generated for the charge interval with the old tariff.

When a fixed charge subsequently arises, this charge is registered with the add-message in the TPP and displayed for the subscriber.

Finally, the charges that have been occurred up to the release of the connection (message, “release” or “REL”) are displayed to the subscriber at the release and the charging time is ended with an end record via a CALL_DATA message.

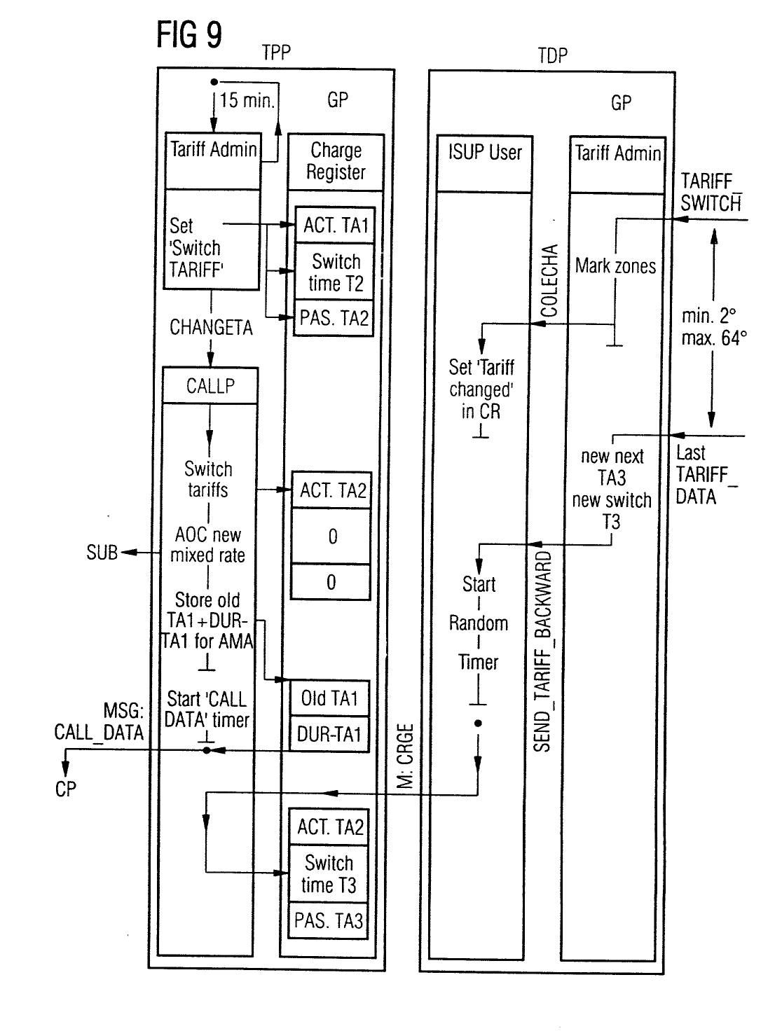

In detail, FIG. 9 shows charge-specific executive sequences in a tariff definition point TDP, i.e. in an exchange that determines the tariff and in a tariff processing point TPP (tariff processing point), i.e. an exchange that implements the charge-specific procedures, whereby the registration (acquisition) of the charging and/or the charge display and/or the charge limit monitoring (not shown in FIG. 9) are to be understood by charge-specific procedures.

The description of the executive sequences in the TDP follows first.

At a tariff switching time, the tariff administration of a group processor GP (the GP respectively controls a line/trunk group of the exchange) is triggered in the TDP by the command “TARIFF SWITCH” (command comes from the central processor CP of the TDP), whereupon the tariff administration implements the following activities:

it makes the passive tariff in the tariff data base the active tariff;

it marks the zones in the tariff switching bit card that are influenced by the tariff switching; and

finally, it sends the message COLECHA to all ISUP Users (an ISUP User is a call-processing instance that contributes to the processing of a call in a transit node).

After reception of said message, said ISUP Users implement the following activities:

they check whether their own, used zone is one of the marked zones for which a tariff switching is relevant;

they cause the flag “Tariff Changed” to be set in the call register CR when said own zone is affected by the tariff switching. Said flag is in turn triggered later by return transmission of a new, passive tariff. Said flag dare not be reset until the message CRGE has been sent.

After the command “TARIFF SWITCH”, the current tariff table of the tariff data base is loaded into the GP via the CP command “TARIFF DATA”, this potentially ensuing repeatedly. The new, passive tariffs are thus loaded. After reception of the last command “TARIFF DATA”, the tariff administration sends the new collective event “SEND TARIFF BACKWARD” to all ISUP users.

Due to the reception of the new collective event “SEND TARIFF BACKWARD”, an ISUP users checks the flag “Tariff Changed” in the call register.

When said flag is set, a new random-controlled timer is started. Given expiration of said random-controlled timer, the new passive tariff together with the appertaining, absolute switching time for the new tariff and, potentially, the current, active tariff is sent in return direction via the expanded CRGE message. Finally, the flag “Tariff Changed” is reset in the call register CR.

Said random-controlled timer protects against a message burst and has the following case-dependent algorithm:

Case 1:

The next tariff switching time is in less than 15 minutes. In this case, the random, controller timer is set to a working range from 0 through 10 minutes.

Case 2:

The next tariff switching time does not occur until more than 15 minutes. In this case, a monitoring is initiated that recognizes—15 minutes before said tariff switching time—that a tariff switching must be implemented. Due to this perception, the random-controlled timer is again started within a working range of 0 through 10 minutes.

In both said instances, the active calls are informed by the CRGE message given expiration of said timer. When an active call is released before said random-controlled timer has run down, said timer is stopped and no tariff information is sent in reverse direction.

The switching functions in the tariff processing point are explained in greater detail below.

Since the received tariff information and their corresponding switching times are only stored in a transient charge register of the GP, the tariff switching function is realized by a cyclical process of the GP. There are two versions for said realization.

In the first version, the central cyclical process checks all tariffs that are to be modified after a quarter-hour has been respectively reached and triggers only the relevant calls. This version serves for dynamic relief of the call processing. For implementation of this version, the process must access all charge registers, check the tariffs contained therein and mark tariffs affected by the switching (Set “Switch Tariff”). When at least one tariff is found, the new collective event “CHANGE TARIFF” (=CHANGETA) is sent to all call processing instances CALLP.

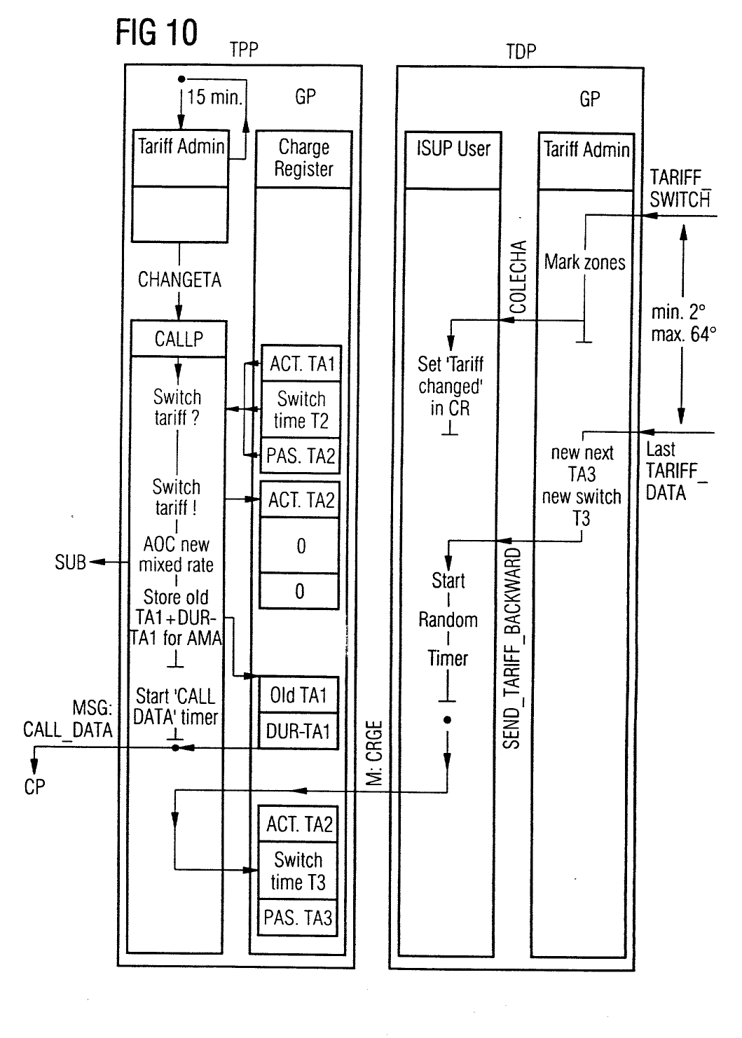

FIG. 10 contains the illustration of the second version. In the second version, the cyclical process triggers all active calls (call processing instances CALLP) after respective quarter half an hour. The calls themselves subsequently check whether tariffs must be switched for them or not. The second version thus assures that only the call processing can access the charge registers (improvement of the data security).

When a tariff switching is necessary, a call processing instance CALLP will immediately switch the tariffs of their call affected by the switching in both versions, i.e.

the call duration DUR-TA1 since the last tariff switching or a charge storing in the CP occurring in the interim is identified (this call duration is used in common for all operators),

the call charging is calculated according to the current active tariff (including that tariff that is changed) and is added to the cumulative sum of the recently currently call charging in the charge register. The current call charging is, in particular, required for the purpose, for example, of charge display and/or of charge limit monitoring.

the current active tariff TA1 is replaced by the next tariff TA2 in the charge register of the GP. Moreover, the next tariff, the tariff switching time and the flag “SWITCH TARIFF” are reset.

the message “CALL DATA” (trigger for generating records in the CP) is sent to the CP with the previously active tariffs of a respective operator. This CALL_DATA message is then deposited by the CP on the disk storage in an AMA data set (automatic message accounting, AMA record in brief), whereby the bill for the subscriber is produced on the basis of the AMA records by the later post-processing. The unmodified tariff of the other operator is likewise co-supplied in the message “CALL DATA” because only a single call duration for AMA (also referred to below as “call duration” or “AMA duration”) that is shared in common for all operator tariffs is used in the charge register CR and in the AMA record. This procedure simplifies the charging procedures in the GP and in the post-processing.

When many or, respectively, all operators wish to change their tariff at the same absolute switching time, the tariff change would effect many or, respectively, all calls and the respective message “CALL DATA” to the CP would have to ensue at this time for many or, respectively, all calls. In order to prevent such a burst and, thus, a possible loss of these messages, the sending of such a message is delayed until the expiration of what is referred to as a “CALL DATA” timer. Said timer is calculated asa follows:

“CALL DATA” timer =call duration modulo (15 minutes) said time is thus derived from the call duration, which is different for each call. In order to maintain the call duration differently for the next tariff switching, the timer for the interim charge storing in the CP dare not be reset. The 15 minutes represent the minimum time interval between two absolute switching times.

because of said delay of the CALL_DATA message, the old tariff (old TA1) and the corresponding call duration (DUR-TA1) for the automatic message accounting must be previously briefly stored in the charge register of the GP before the new tariff is activated.

the call duration used in common, finally, is reset and a new time stamp is set.

upon reception of a new CRGE message, the call instance updates is charge register with the new, passive tariff and the new tariff switching time (potentially with the current, co-supplied tariff).

1. Method for charging connections in a communication network that comprises a plurality of sub-networks of different operators, in accord wherewith a tariff of a connection is determined in a tariff determination point (TDP) of a sub-network and is transmitted to a tariff processing point (TPP) with the assistance of a tariff message, the charge-specific events being implemented by said tariff processing point on the basis of the received tariffs, characterized in that a tariff of a connection is explicitly indicated in a tariff message, i.e. in tariff units per tariff interval (time clock).

2. Method according to claim 1, characterized in that the tariff units are indicated in a currency format.

3. Method according to claim 1, characterized in that the tariff units are indicated in a meter pulse format.

4. Method according to one of the claims 1 through 3, characterized in that the tariff message is only used in an originating exchange for the purpose of displaying the charging when it is noted in the tariff message that the tariff message has already been employed for the purpose of registering the charging.

5. Method according to one of the claims 1 through 4, characterized in that a current tariff and/or a next-successive tariff with appertaining tariff switching time for the next-successive tariff are transmitted in a tariff message (CRGE).

6. Method according to one of the claims 1 through 5, characterized in that a current tariff and a next-successive tariff with appertaining tariff switching time for the next-successive tariff are transmitted in a tariff message (CRGE) at the beginning of a connection.

7. Method according to one of the claims 1 through 5, characterized in that a tariff message (CRGE) during a connection is interpreted by the TPP as a command for an immediate tariff switching when the tariff message contains only a current tariff.

8. Method according to one of the claims 1 through 7, characterized in that tariff messages of a TDP for various connections that contain the same tariff switching are sent time-different.
